(19) United States
(12) Patent Application Publication
(10) Pub. No.: US 2019/0022937 A1
(43) Pub. Date: Jan. 24, 2019

(54) BUILDING WITH CYLINDRICAL LAYERS IN ADDITIVE MANUFACTURING

(71) Applicant: Evolve Additive Solutions, Inc., Minnetonka, MN (US)

(72) Inventors: Eric Carl Stelter, Lexington, KY (US); Steven A. Chillscyzn, Victoria, MN (US); Jerome Geotzke, Mahtomedi, MN (US)

(21) Appl. No.: 16/066,944

(22) PCT Filed: Dec. 29, 2016
(86) PCT No.: PCT/US2016/069179

§ 371 Date: Jun. 28, 2018

Related U.S. Application Data
(60) Provisional application No. 62/273,910, filed on Dec. 31, 2015.
(60) Provisional application No. 62/273,873, filed on Dec. 31, 2015.
(60) Provisional application No. 62/273,903, filed on Dec. 31, 2015.

(51) Int. Cl. B29C 64/218; B29C 64/393; B29C 64/245

(52) U.S. Cl. CPC B29C 64/218; B33Y 10/00; B29C 64/245; B29C 64/393

(57) ABSTRACT

An additive manufacturing system for printing a three-dimensional part includes a build roller that rotates while receiving part material such that layers of part material are formed on a cylindrical base of the build roller in a cylindrical scroll to form the three-dimensional part, wherein the part material of adjacent layers of part material are bonded together on the build roller, and wherein the three-dimensional part can be non-cylindrical.

### BACKGROUND

The present disclosure relates to systems and methods for additive manufacturing of three-dimensional (3D) parts. In particular, the present disclosure relates to additive manufacturing systems and processes for building 3D parts and support structures using an imaging process.

Additive manufacturing is generally a process for manufacturing a three-dimensional (3D) object an additive manner utilizing a computer model of the objects. The basic operation of an additive manufacturing system consists of slicing a three-dimensional computer model into thin cross sections, translating the result into position data, and providing the position data to control equipment which manufacture a three-dimensional structure in a layerwise manner using one or more additive manufacturing techniques. Additive manufacturing entails many different approaches to the method of fabrication, including fused deposition modeling, ink jetting, selective laser sintering, powder/binder jetting, electron-beam melting, electrophotographic imaging, and stereolithographic processes.

For example, in an extrusion-based additive manufacturing system, a 3D part or model may be printed from a digital representation of the 3D part in a layer-by-layer manner by extruding a flowable part material. The part material is extruded through an extrusion tip carried by a print head of the system, and is deposited as a sequence of roads on a substrate in an x-y plane. The extruded part material fuses to previously deposited part material, and solidifies upon a drop in temperature. The position of the print head relative to the substrate is then incremented along a z-axis (perpendicular to the x-y plane), and the process is then repeated to form a 3D part resembling the digital representation. In this process, the 3D part is sliced in rectilinear (x,y,z) coordinates, the part is stationary, and the print head is moved through a series of rectilinear displacements relative to the substrate to build the part on a planar substrate.

In fabricating 3D parts by depositing layers of a part material, supporting layers or structures are typically built underneath overhanging portions or in cavities of objects under construction, which are not supported by the part material itself. A support structure may be built utilizing the same deposition techniques by which the part material is deposited. A host computer generates additional geometry acting as a support structure for the overhanging or free-space segments of the 3D part being formed. The support material adheres to the part material during fabrication, and is removable from the completed 3D part when the printing process is complete.

In two-dimensional (2D) printing, electrophotography (i.e., xerography) and ink jet are popular technologies for creating 2D images on planar substrates, such as printing paper. Most electrophotographic systems include a conductive support drum coated with a photoconductive material layer to form a photoconductor drum. In the most common implementation, latent electrostatic images are formed by charging the photoconductor drum and then image-wise exposing it with an optical source. For digital printers, the optical source is a linear LED print head or a scanning laser light source. These are used to expose the photoconductive material layer in a line-by-line fashion laterally along the length of the drum. The latent electrostatic images are then moved to a developing station where toner from a developer roller adjacent to the photoconductor drum is applied to discharged areas of the photoconductive insulator to form visible images. This is referred to as discharge area development. The formed toner images are then transferred to substrates (e.g., printing paper) and affixed to the substrates with heat or pressure.

Ink jet office printers use a similar geometry where ink jet print heads are moved in rectilinear fashion in a reciprocating motion to print laterally across a sheet of paper or other receiver typically supported by a roller or drum adjacent to the path of the print head. Ink jet production printers use a full width linear array of print heads to print across the width of a moving web of paper. Both ink jet and electrophotographic printers that print on an essentially flat paper substrate can be described as planar printers.

In an electrophotographic 3D printing process, each slice of the digital representation of the 3D part is printed or developed using an electrophotographic engine. The electrophotographic engine generally operates in accordance with 2D electrophotographic printing processes and uses a polymeric toner. For 3D printing, the electrophotographic engine typically uses a conductive support drum that is coated with a photoconductive material layer, where latent electrostatic images are formed by electrostatic charging, followed by image-wise exposure of the photoconductive layer by an optical source. The latent electrostatic images are then moved to a developing station where the polymeric toner is applied from a development roller to discharged areas, or alternatively to charged areas of the photoconductor to form the layer of the polymeric toner representing a slice of the 3D part. The developed layer is conveyed to a transfer medium, from which the layer is transferred onto previously printed layers with heat and/or pressure to build the 3D part.

Ink jet 3D printing processes use a process very similar to the extrusion-based additive manufacturing system described previously, in that the print head prints the 3D part or model in a layer-by-layer manner by jetting part material or binder. The print head of the system moves in a rectilinear path above a substrate in an x-y plane. The jetted part material is solidified on previously deposited part material. The position of the print head relative to the substrate is then incremented along a z-axis (perpendicular to the x-y plane), and the process is then repeated to form a 3D part resembling the digital representation. In this process, the 3D part is sliced in rectilinear (x,y,z) coordinates, the part is stationary, and the print head is moved through a series of rectilinear displacements with respect to the substrate.

Both ink jet and electrophotography use a linear writing process to produce layers of a 3D part one layer at a time. The scanning laser light source in electrophotographic printers is analogous to the reciprocating print head in ink jet office printers. The LED bar in electrophotographic printers is analogous to the full width print head array in ink jet production printers. Printers that use a linear writing system, like a scanning laser light source, LED bar, or full width ink jet print head, can be referred to as linear printers. Also, for both ink jet and electrophotography, a digital representation of a single layer of the part can be divided into multiple portions, usually one per color, which are referred to as separations. Although many single-layer printers are linear, not all single-layer printers are linear. For example, electrophotographic flash copiers expose an entire plane of photoconductor material simultaneously for each separation.

### SUMMARY

An additive manufacturing system for printing a three-dimensional part includes a build roller that rotates while receiving part material such that cylindrical layers of part material are formed on the build roller to form the three-dimensional part, wherein the three-dimensional part is non-cylindrical.

In a further embodiment, an additive manufacturing system includes a build roller that rotates while receiving part material and support material such that cylindrical layers of part material and support material are formed on the build roller to form a three-dimensional part surrounded or supported by support material.

In a further embodiment, the digital representation of the layers of part material and support material are in the form of segments of a cylindrical arc, a full circular cylindrical arc, segments of a cylindrical spiral, or in the form of a continuous cylindrical scroll that can contain segments of spirals and segments of arcs.

In a further embodiment, the layers of part material and support material are in the form of segments of a cylindrical arc or in the form of a complete cylindrical arc. The structure formed on the build roller by the layers of part material and support material is called a build cylinder. The radius of the build cylinder increases as infrequently as once per revolution of the build cylinder, or as frequently as desired.

In a preferred embodiment, the layers of part material and support material are in the form of segments of a cylindrical spiral or in the form of a continuous cylindrical spiral. The radius of the build cylinder increases continuously with every printed point along the length of the cylindrical spiral as the cylindrical spiral is applied to the build roller.

In a still further embodiment, a method involves forming a first cylindrical slice of a part and transfusing a second cylindrical slice of the part onto the first cylindrical slice of the part.

An additive manufacturing system includes a printer and a transfer medium. The printer creates a layer of material based on coordinates of print points representing a cylindrical arc slice of a three-dimensional part or representing a cylindrical spiral slice of a three-dimensional part. If the transfer medium transfers the layer of material onto a build cylinder in the form of a cylindrical arc slice, the radius of the build cylinder increases as infrequently as once per revolution of the build cylinder, or as frequently as desired as the cylindrical arc is applied to the build cylinder. If the transfer medium transfers the layer of material onto a build cylinder in the form of a cylindrical spiral slice, the radius of the build cylinder increases continuously with every printed point along the length of the cylindrical spiral as the cylindrical spiral is applied to the build roller. A cylindrical slice can contain both cylindrical arc slices and cylindrical spiral slices. The length of the cylindrical slice can be less than the circumference of the roller, equal to the circumference of the roller, or greater than the circumference of the roller and overlap onto itself.

A computer-implemented method includes orienting a part surface in a cylindrical build space and identifying an intersection between the part surface and a cylindrical arc or a cylindrical spiral. For each of a set of discrete angle values along the cylindrical arc or cylindrical spiral at which the intersection is present, at least one print point is stored in memory. The print points are determined and stored in memory in a same order in which the print points will be printed.

In a further embodiment, an additive manufacturing system includes a controller that receives coordinates for print points of a three-dimensional surface, each print point represented as a portion of a cylindrical arc slice or a cylindrical spiral slice of the three-dimensional surface. A printer assembly receives the coordinates for the print points from the controller and in response prints a planar layer of material and solidifies or bonds the planar layer of material onto a build roller to form a build cylinder that contains the three-dimensional surface.

An additive manufacturing system includes a printer and a transfer medium. The printer prints material onto a conveyor assembly. The transfer medium receives the material from the conveyor assembly and places the material on a build cylinder in the form of a cylinder segment or a cylindrical scroll segment. The radius of curvature of the cylinder segment or cylindrical scroll segment is perpendicular to the axis of the build cylinder.

A method of additive manufacturing includes depositing printed material on a conveyor assembly and moving the printed material using the conveyor assembly. The printed material is released from the conveyor assembly onto to a transfer drum and material from the transfer drum is transferred and bonded onto a build cylinder.

In a further embodiment, an additive manufacturing system includes a transfer drum carrying material and a sintering roller that applies pressure to the material on the transfer drum to increase the density of the material on the transfer drum to thereby form a condensed material. A planar build substrate or a build cylinder receives the condensed material. The sintering roller applies significantly more pressure to the material on the transfer drum to condense the material than the pressure that is applied when the condensed material is transferred to the planar build substrate or build cylinder.

### Definitions

Unless otherwise specified, the following terms as used herein have the meanings provided below:

The term “cylindrical arc” refers to all or a portion of cylindrical layer having a constant radius or a radius that changes discretely as a function of an angle.

The term “cylindrical spiral” refers to all or a portion of a cylindrical layer having a radius that increases continuously as a function of an angle.

The term “cylindrical” and “cylindrical shapes” include both cylindrical arcs and cylindrical spirals”.

The term “cylindrical scroll” include both cylindrical arcs and cylindrical spirals and combinations of cylindrical arcs and cylindrical spirals that together extend around more than one rotation of a cylinder.

Unless otherwise specified, pressures referred to herein are based on atmospheric pressure (i.e. one atmosphere).

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis. In particular, when the printing axis is the radius of a cylinder, the terms “above”, “below”, “top”, “bottom”, and the like are relative to the radial direction.

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability.

The terms “about” and “substantially” and “approximately” and other similar terms are used herein with respect to measurable values and ranges due to expected variations known to those skilled in the art (e.g., limitations and variabilities in measurements).

### BRIEF DESCRIPTION OF THE DRAWINGS

FIG. 1a is block diagram of an additive manufacturing system in accordance with various embodiments.

FIG. 1b is block diagram of an additive manufacturing system in accordance with various embodiments.

FIG. 1c is block diagram of an additive manufacturing system in accordance with various embodiments.

FIG. 2 is a side view of an exemplary single-layer printer utilitzed as a planar printer.

FIG. 3 is a front view of portions of an additive manufacturing system in accordance with one embodiment

FIG. 4 is a perspective front view of the system of FIG. 3.

FIG. 5a is a rear view of an embodiment of the system of FIG. 3.

FIG. 5b is a rear view of an embodiment of the system of FIG. 3.

FIG. 6 is a front view of the system of FIG. 3 after a number of layers of transferred material has been built on the build cylinder.

FIG. 7 is a front perspective view of the system of FIG. 6.

FIG. 8 is a sectional perspective view of a portion of the build cylinder of FIG. 7.

FIG. 9 provides a flow diagram in accordance with an exemplary method of converting three-dimensional models into a collection of print points.

FIG. 10 provides a flow diagram of a method of printing parts using an additive manufacturing system in accordance with various embodiments.

FIG. 11 provides a block diagram of a computing system that can be used as part of a host computer or controller in accordance with some embodiments.

### DETAILED DESCRIPTION

The present disclosure is directed to building three-dimensional (3D) parts on a build cylinder. Material for the parts and surrounding support structures is printed with a single-layer printer onto the build cylinder. With each rotation of the build cylinder, a cylindrical slice is added to the parts and the support structures thereby causing the radius of the build cylinder to increase. A cylindrical slice can contain cylindrical arc slices and/or cylindrical spiral slices. For cylindrical arc slices, the radius of the build cylinder is constant along some angular portions and increases by discrete amounts at certain angular positions. For cylindrical spiral slices, the radius of the build cylinder increases continuously with every printed point along the length of the cylindrical spiral as the build cylinder is rotated. Material can be printed directly onto the build cylinder by one or more single-layer printers and solidified later, or material can be printed onto a transfer medium which then transfers the material onto the build cylinder so that the material bonds with the existing material on the build cylinder or the material can be printed onto a conveyor assembly that conveys the material to a transfer medium that transfers the material onto the build cylinder. More than one transfer medium can be used with two or more single-layer printers. More than one conveyor assembly can be used with two or more single-layer printers and at least one transfer medium. The material added to the build layer is bonded to the build layer, usually by heat and pressure or by chemical means. When the parts are finished, they are removed from the build cylinder by separating the parts from the surrounding support structures.

In order to print the layers of the parts and surrounding support structures, models of the parts, and in some cases the surrounding support structures, are oriented in a cylindrical build space and then sliced into cylindrical arc slices that have the form of arc segments of constant radius or sliced into cylindrical spiral slices that have the form of a spiral of increasing radius. This slicing also produces a set of planar coordinates for each print point of the parts. A corresponding print radius can be assigned to each pair of planar coordinates. In accordance with one embodiment, the planar coordinates are such that with the rotation of the build cylinder, the value of one of the coordinates parallel to the direction of rotation of the build cylinder increases. This is defined as the x coordinate. It has an analog in planar printing. In a planar printer, the x coordinate is parallel to the process direction and increases in the process direction. If the process direction in a planar printer is from left to right, the x coordinate increases from left to right and the y coordinate increases from the front of the printer to the back of the printer. If a build cylinder is rotating clockwise, the process direction is the direction of rotation, the x coordinate increases in the direction of rotation, and the y coordinate increases from the front of the build cylinder to the back of the build cylinder. If planar slices being printed in a planar printer are stacked onto previous horizontal slices, the vertical axis is the print axis z. If planar slices are applied as cylindrical slices to a build cylinder rotating clockwise, the print radius r is a vertical axis in the planer printer and a radial axis on the build cylinder. In accordance with some embodiments, the planar coordinates for the print points are stored in memory in a same order in which the print points will be printed on the planar surface.

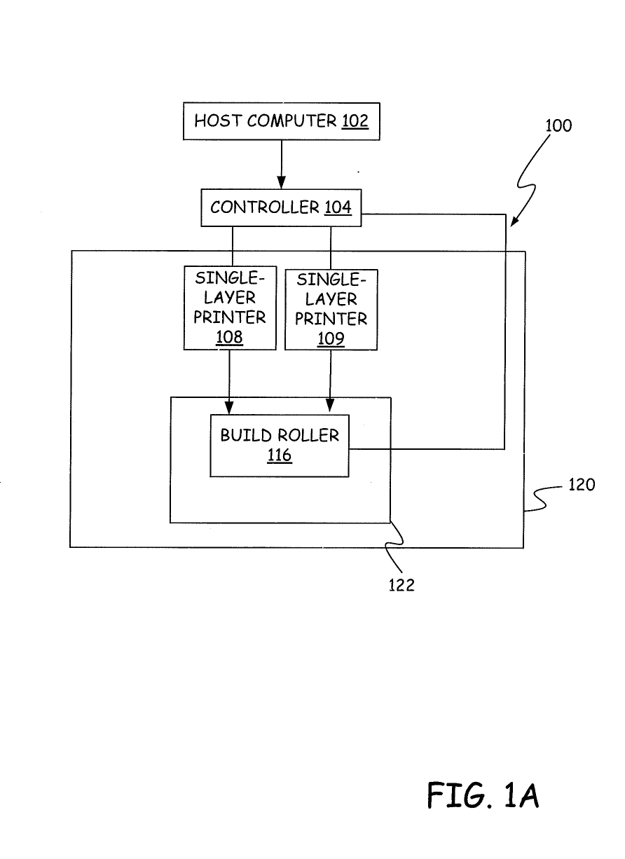

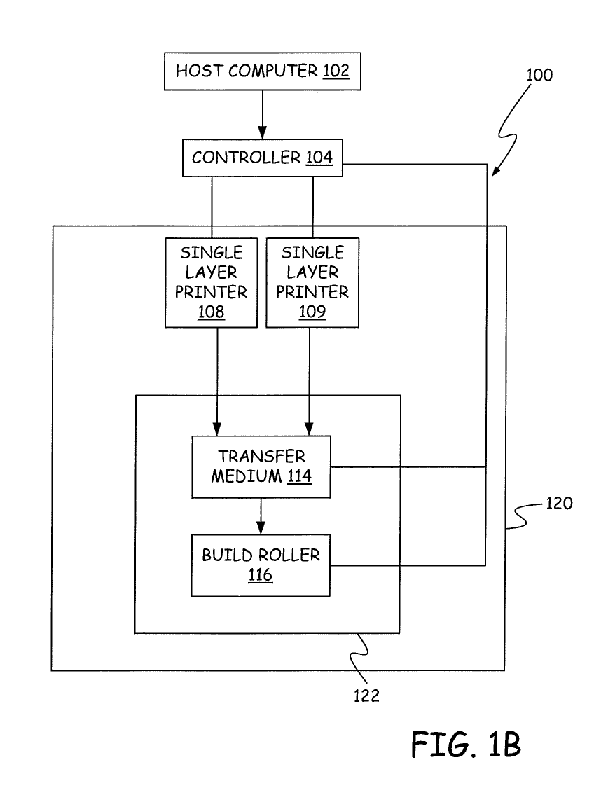

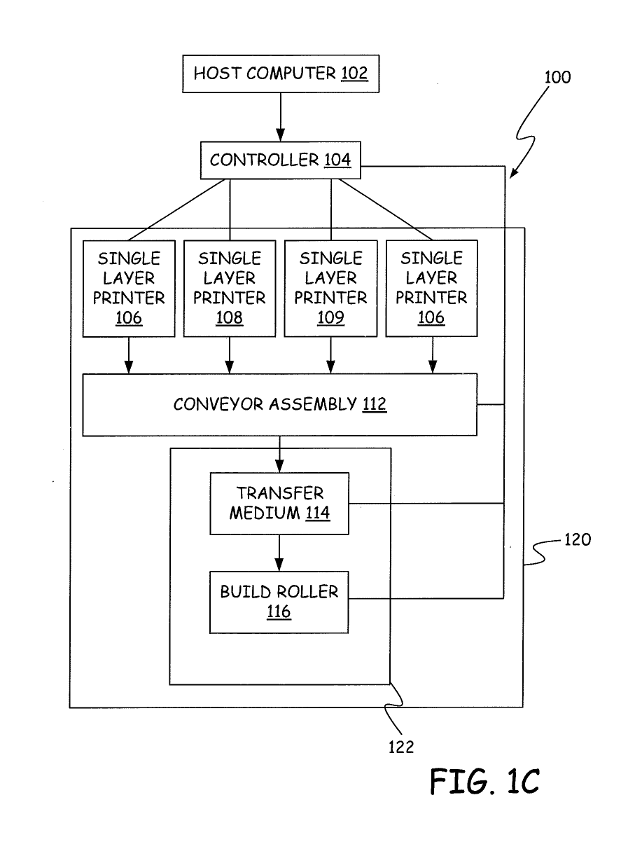

FIGS. 1a, 1b, and 1c, all numbered alike, provide block diagrams of an exemplary additive manufacturing system 100 for printing 3D parts and support structures using single-layer printers and a cylindrical build platform in accordance with some embodiments. In FIG. 1a, system 100 includes a host computer 102, a controller 104, and a printer assembly consisting of at least one of single-layer printers 108, 109 and a build roller 116. In FIG. 1b, system 100 includes a host computer 102, a controller 104, and a printer assembly consisting of at least one of single-layer printers 108, 109, a transfer medium 114 and a build roller 116. In FIG. 1c, system 100 includes a host computer 102, a controller 104, and a printer assembly consisting of at least one of single-layer printers 106, 108, 109 and 110, a conveyor assembly 112, a transfer medium 114 and a build roller 116. In accordance with some embodiments, at least single-layer printers 106, 108, 109 and 110, conveyor assembly 112, transfer medium 114 and build roller 116 can be retained within a housing 120. Parts or all of host computer 102 and controller 104 may also be retained within housing 120. This housing may contain an oven 122 surrounding at least the build roller 116. Note that although two single-layer printers are shown in FIG. 1a, two single-layer printers are shown in FIG. 1b and four single-layer printers are shown in FIG. 1c, different numbers of single-layer printers are used in other embodiments. In accordance with some embodiments, a separate single-layer printer is provided for each material used to build the part or support structures.

Host computer 102 is one or more computer-based systems configured to provide print instructions (and other operating information) that can be used to print three-dimensional parts on a cylindrical build platform. For example, host computer 102 may transfer information that describes sliced layers of 3D parts that are to be built on the cylindrical build platform. Host computer 102 provides the print instructions and operating information to controller 104, which is configured to operate the remaining components of system 100 in a synchronized manner based on the printing instructions received from host computer 102. In accordance with some embodiments, controller 104 is one or more control circuits, microprocessor-based engine control systems, and/or digitally-controlled raster imaging processor systems.

Controller 104 implements the printing instructions from host computer 102 by generating and transmitting control signals to control the remaining components of system 100 including single-layer printers 106, 108, 109 and 110, conveyor assembly 112, transfer medium 114 and build roller 116. In particular, controller 104 sends control signals to each of the single-layer printers to cause the single-layer printers to generate materials one layer at a time which are then added as cylindrical layers to build roller 116 to thereby form the 3D parts and support structures. In accordance with some embodiments, different single-layer printers print different portions of the layer. For example, a first single-layer printer may print metal portions of the layer while a second single-layer printer prints a first polymeric part material portions of the layer and a third single-layer printer prints a second polymeric part material and a fourth single-layer printer prints structural support portions of the layer. Any of the materials printed by single-layer printers 106, 108, 109, and 110 may be adjacent to any other material printed by any other of the single-layer printers 106, 108, 109, or 110. Or, any material printed by single-layer printers 106, 108, 109, and 110 may be adjacent to an area with no printed material. Also, in some instances, material printed by one single-layer printer may be deposited on top of material printed by another single-layer printer. Controller 104 also provides signals to conveyor assembly 112 that cause the conveyor assembly to move the single layer of materials between the different single-layer printers and to move the layer of material from the single-layer printers to transfer medium 114. Controller 104 provides signals to transfer medium 114 that cause the single layer to disassociate from the transfer medium and to bond to build roller 116 or to existing formations in a build cylinder on build roller 116.

Examples of printer technology that can be used for single-layer printers 106, 108, 109 and 110 include extrusion-based techniques, jetting, selective laser sintering, high speed sintering, powder/binder jetting, electron-beam melting, stereolithographic processes, thermal transfer, magnetography, ionography, direct pixel-wise deposition of toner, liquid electrophotography and electrophotography with particulate toner, similar to that commonly used in office imaging, for example. In addition, different single-layer printers in system 100 can use different printing techniques. For example, single-layer printer 106 could use selective laser sintering while single-layer printer 108 uses electrophotography.

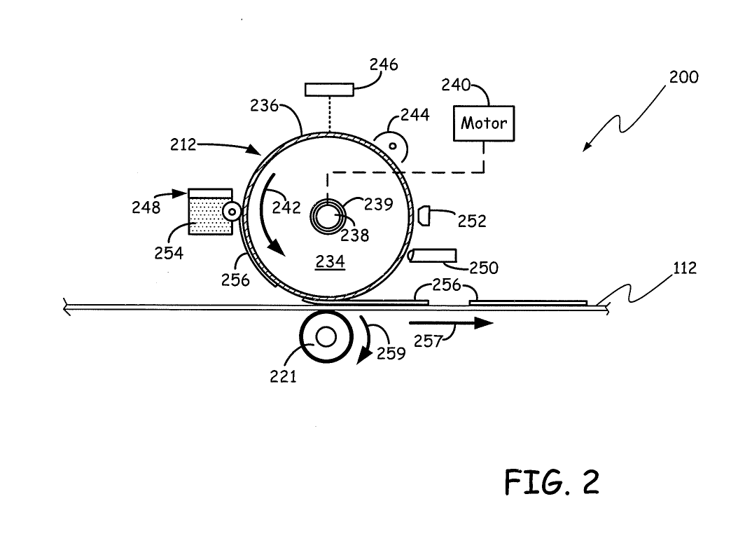

FIG. 2 provides a side view of an exemplary imaging engine 200 that can be used as one or more of single-layer printers 106, 108, 109, and 110. As shown in FIG. 2, imaging engine 200 is an electrophotographic engine that includes drive motor 240, shaft 238, encoder 239, photoconductor drum 212, biased roller 221, charge inducer 244, imager 246, development station 248, discharge device 250 and cleaning station 252, each of which may be in signal communication with controller 104. Charge inducer 244, imager 246, development station 248, discharge device 250, and cleaning station 252 of imaging engine 200 accordingly define an image-forming assembly for surface 236 while drive motor 240 and shaft 238 rotate photoconductor drum 212 in the direction of arrow 242.

Photoconductor drum 212 includes conductive drum 234 and photoconductive surface 236, where conductive drum 234 is an electrically-conductive drum (e.g., fabricated from copper, aluminum, tin, or the like) that is electrically grounded and configured to rotate around shaft 238. While described herein as a drum, photoconductor drum 212 may alternatively be a roller, a belt assembly, or other rotatable assembly. Shaft 238 is correspondingly connected to drive motor 240, which is configured to rotate shaft 238 and encoder 239 (and photoconductor drum 212) in the direction of arrow 242 at a constant rate.

Photoconductive surface 236 is a thin film extending around the circumferential surface of conductive drum 234, and is derived from one or more photoconductive materials, such as amorphous silicon, selenium, zinc oxide, organic materials, and the like. Charge inducer 244 is configured to generate a uniform electrostatic charge on surface 236 as surface 236 rotates in the direction of arrow 242 past charge inducer 244. Suitable devices for charge inducer 244 include corotrons, scorotrons, charging rollers, and other electrostatic charging devices.

Imager 246 is a digitally-controlled, pixel-wise light exposure apparatus configured to selectively emit electromagnetic radiation toward the uniform electrostatic charge on surface 236 as surface 236 rotates in the direction of arrow 242 past imager 246. The selective exposure of the electromagnetic radiation to surface 236 is directed by controller 104, and causes discrete pixel-wise locations of the electrostatic charge to be removed (i.e., discharged to ground), thereby forming latent image charge patterns on surface 236. Suitable devices for imager 246 include scanning laser (e.g., gas or solid state lasers) light sources, light emitting diode (LED) array exposure devices, and other exposure device conventionally used in 2D electrophotographic systems. In alternative embodiments, suitable devices for imager 242 and charge inducer 244 include ion-deposition systems configured to selectively directly deposit charged ions or electrons to surface 236 to form the latent image charge pattern. As such, as used herein, the term “electrophotography” includes ionography.

The pixel-wise locations exposed by imager 246 correspond with cylindrical arc slices or cylindrical spiral slices of parts and support structures where the cylindrical arc slices and cylindrical spiral slices can be joined together at their ends to form a continuous scroll slice through the parts and support structures. The continuous scroll slice wraps around itself in ever-increasing radii such that different portions of the continuous scroll slice will contain different cylindrical layers of a part. The continuous scroll slice can also be unwound and oriented in an x-y plane with y representing a location along a width of conveyor assembly 112 (the width extending into the page in FIG. 2) and x representing a position between a radially inner-most position on the continuous scroll slice and a radially outer-most position on the continuous scroll slice. To identify the pixel-wise locations that are exposed by the imager, the continuous scroll slice is divided into pixels in the x-y plane and if a pixel contains a layer of the part material or structural support material that is printed by the imaging engine, the pixel will be exposed by imager 246 (or not exposed, if using negative imaging or charged area development).

Development station 248 is preferably an electrostatic and magnetic development station that retains a supply of material 254 in powder form, and that applies material 254 to surface 236. (Note the size of the container holding material 254 is not to scale and that in most embodiments the container is much larger.) As surface 236 (containing the latent charged image) rotates from imager 246 to development station 248 in the direction of arrow 242, material 254 is attracted to the appropriately charged regions of the latent image on surface 236, utilizing either charged area development or discharged area development (depending on the electrophotography mode being utilized). This creates a continuous or intermittent web 256 of material 254 as photoconductor drum 212 continues to rotate in the direction of arrow 242, where web 256 contains multiple successive portions of the sliced layers of the digital representation of the 3D parts and support structures. Note that in some embodiments, the sliced layers of the 3D parts and support structures do not need to be separated by a space on web 256.

Development station 248 may function in a similar manner to single or dual component development systems and toner cartridges used in 2D electrophotography systems. For example, development station 248 may include an enclosure for retaining the charged material 254, and one or more devices for transferring the charged material 254 to surface 236, such as conveyor, fur brushes, paddle wheels, rollers, and/or magnetic brushes. Suitable materials for material 254 may vary depending on the desired part properties, such as one or more thermoplastic resins, one or more metals, and one or more glasses or ceramics. Examples of suitable thermoplastic resins for material 254 include polyolefins, polyester, nylon, toner materials (e.g., polyester or styrene-acrylate/acrylic materials), ABS, and combinations thereof. In dual-component arrangements, material 254 may also include a magnetic carrier material with the thermoplastic resin(s). For example, the magnetic carrier material may be coated with an appropriate material to triboelectrically charge the thermoplastic resin(s) of material 254.

Web 256 of material 254 is then rotated with surface 236 in the direction of arrow 242 to a transfer region in which web 256 is transferred from photoconductor drum 212 to conveyor assembly 112, which in the embodiment of FIG. 2 takes the form of a belt. After photoconductor drum 212 releases web 256, the region of surface 236 that previously held web 256 passes discharge device 250 and cleaning station 252. Cleaning station 252 is a station configured to remove any residual, non-transferred portions of material 254. Suitable devices for cleaning station 252 include blade cleaners, brush cleaners, electrostatic cleaners, vacuum-based cleaners, and combinations thereof.

Discharge device 250 aids cleaning station 252 and removes any residual electrostatic charge on surface 236, prior to starting the next cycle. Suitable devices for discharge device 250 include light-emitting or infra-red optical systems, high-voltage alternating-current corotrons and/or scorotrons, one or more rotating dielectric rollers having conductive cores with applied high-voltage alternating-current, and combinations thereof.

Although FIG. 2 provides one example architecture for electrophotography printing, other architectures are used in other embodiments. For example, monocomponent electrophotography or liquid electrophotography are used in other embodiments. In addition, other methods of printing a single layer of material can be used such as thermal transfer, laser ablation, hot foil stamping, embossing, jetting or imagewise curing using for example UV, laser, vapor, IR, microwave, or ebeam and other forms of radiation, including ionizing radiation. Alternatively imaged layers can be dried in an oven, similar to coil coating. In accordance with a still further embodiment migration imaging is used where particles migrate to the top or the bottom of a liquid layer, and then are transferred. As noted above, the single layers can be applied directly to build roller 116, to a transfer medium 114 or to conveyor assembly 112.

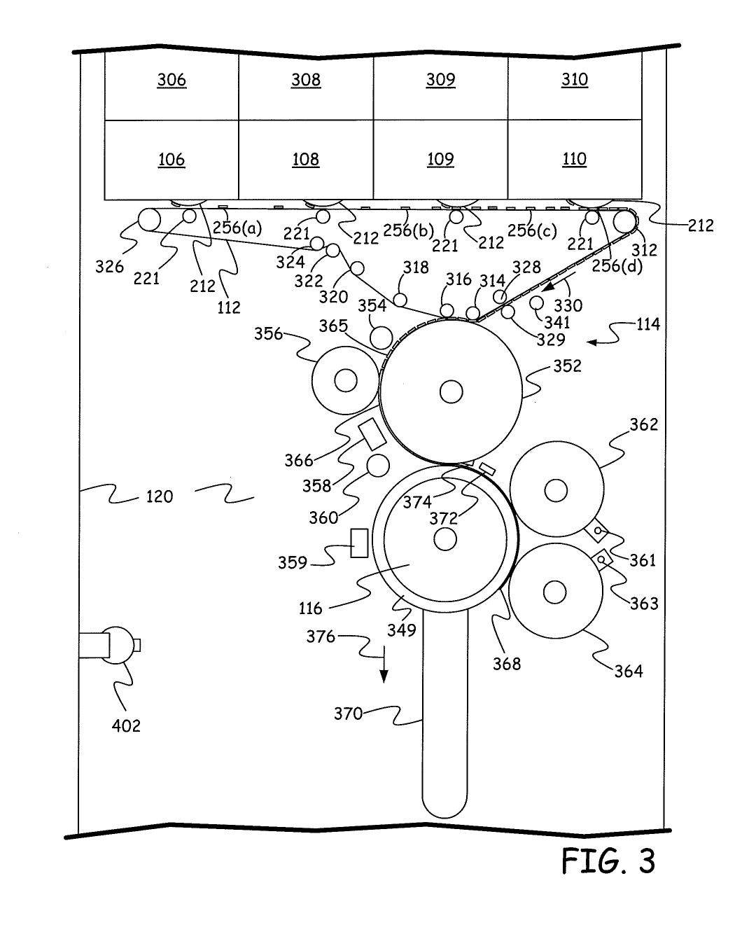

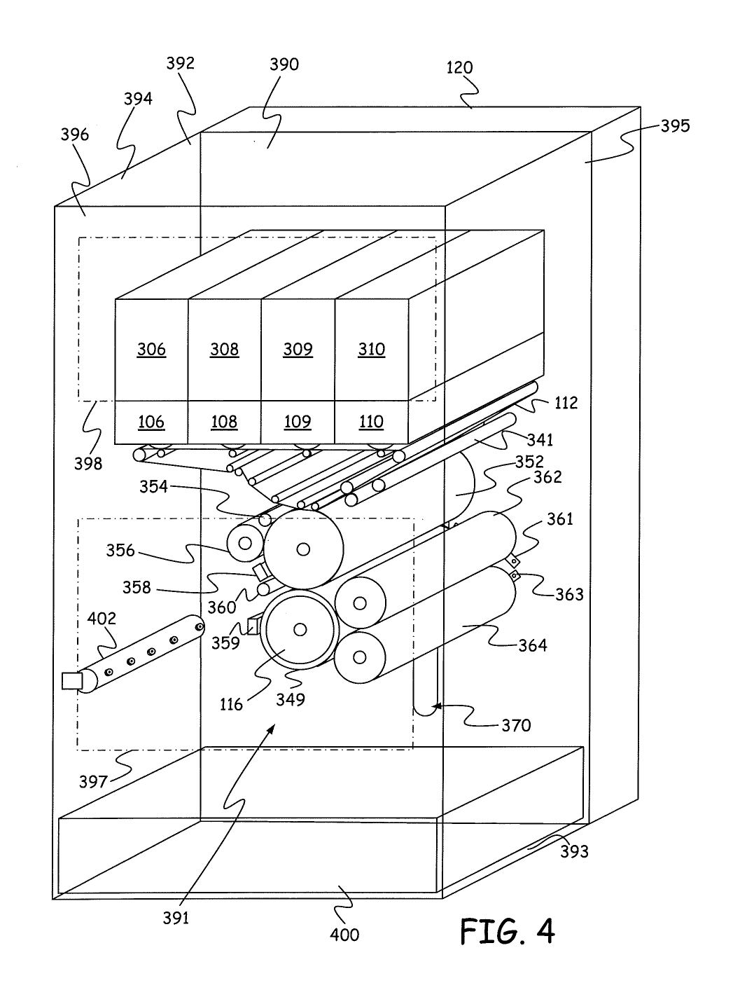

FIGS. 3, 4 and 5 provide an enlarged front view, a perspective front view and a rear view, respectively, of portions of system 100 in accordance with one embodiment. As shown in FIG. 4, single-layer printers 106, 108, 109 and 110 are mounted on a cabinet dividing wall 390 of housing 120 and extend into an enclosed and sealed space 391 defined by dividing wall 390, top wall 392, floor 393, side walls 394 and 395 and a front wall 396. Front wall 396 includes one or more doors such as doors 397 and 398 shown in phantom lines in FIG. 4 (the doors are not shown in FIG. 3 for the sake of clarity). In accordance with some embodiments, a drawer 400 is positioned at the bottom of housing 120 and can be pulled out of sealed space 391 through an opening in front wall 396.

Each of single-layer printers 106, 108, 109, and 110 have a respective material supply cartridge 306, 308, 309 and 310, which contain respective material that is used by the single-layer printer to print material on conveyor assembly 112. In accordance with some embodiments, each material supply cartridge provides a different material such that four different materials may be used in the printing processes. Examples of the part materials include those listed above for development station 248. In addition, one or more of the material supply cartridges may contain a support material used to support the parts while the parts are being built.

Single-layer printers 106, 108, 109 and 110 deposit or print respective material 256(a), 256(b), 256(c) and 256(d) on conveyor assembly 112. Together, materials 256(a), 256(b), 256(c) and 256(d) form a planar printed layer of materials representing a scroll slice through the parts to be constructed on cylindrical build roller 116.

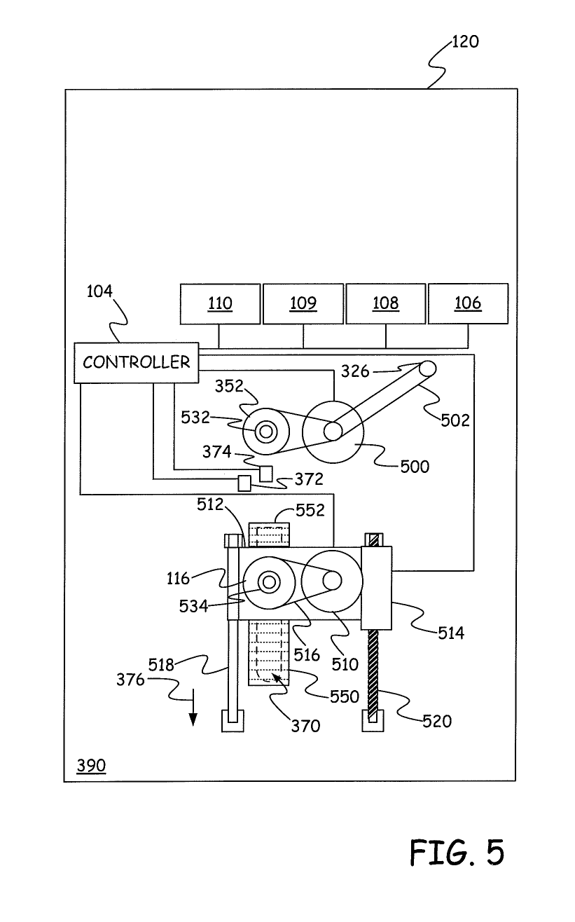

Conveyor assembly 112 is a closed loop belt that is mounted on a series of rollers, such as rollers 312, 314, 316, 318, 320, 322, 324, and 326 and is substantially planar beneath the single-layer printers. The rollers keep the transfer belt of conveyor assembly 112 at a desired tension to prevent wrinkles in the material 256 deposited on the belt. Preferably, the transfer belt is seamless. As shown in FIG. 5, roller 326 is connected to a motor 500 by a drive belt 502. As motor 500 rotates, drive belt 502 rotates roller 326, thereby causing the transfer belt to move in a rotational direction 330 such that materials 256 printed on the transfer belt by single-layer printers 106, 108, 109, and 110 are carried around roller 312 and down toward transfer medium 114. Alternately, other rollers may be driven instead of roller 326. For example, roller 312 can be driven, or rollers 322 and 324 can be driven. The speed of motor 500 is controlled by controller 104 to match the speed at which single-layer printers 106, 108, 109 and 110 can successfully deposit material on the transfer belt. Transfer member 114 includes a transfer drum or roller 352, a sintering roller 356, a charging device 358, a charging device 359, a press roller 362, a cooling roller 364, and heaters 354 and 360. Transfer drum 352, which in one embodiment is a hard anodized aluminum impregnated with teflon, is rotated by motor 500 and a belt 504 (FIG. 5) at a constant speed that matches the speed of the transfer belt. Alternately, the speed of motor 500 can be driven so that the surface speed of transfer drum or roller 352 matches the surface speed of photoconductor 212. Various other drive configurations can be used as is known in the art.

Materials 256 on the transfer belt are released onto transfer drum 352 as released materials 365. Electrostatic transfer is preferably used to release electrically-charged materials 256 from the transfer belt and onto transfer drum 352. Electrostatic transfer is performed by electrically biasing roller 314 with respect to roller 352 to attract charged material to roller 352. It may be necessary to charge materials 256 on the transfer belt with charging device 359, which is preferably a corona charger. Typical bias voltages between roller 314 and roller 352 are on the order of 300 Volts to 1000 Volts. However, greater voltages may be required for thick or highly charged layers of material. Materials 256 can also be heated by heater 341 or by contact heaters 328 and 329, which can be rollers or belts that may also compress materials 256. Charging device 329 may be placed either before or after these heaters to facilitate electrostatic transfer of materials 256 to transfer drum 352. At least some of released materials 365 can be relatively uncompressed powders. For example, when electrophotographic printers are used as the single-layer printers, released materials 365 are approximately 40% air and 60% material by volume. In addition, when materials 365 are released from the transfer belt, the materials are usually at a temperature below the glass transition temperatures of the materials. To facilitate the transfer of the materials from the transfer belt to transfer drum 352, transfer drum 352 is maintained at a temperature that is approximately at or above the bonding temperature of the materials on the transfer belt. The bonding temperature is the low end of the temperature range for welding the materials. It can be less than the glass transition temperature, approximately the same as the glass transition temperature, or greater than the glass transition temperature. It is usually less than the melting temperature of the material. Transfer drum 352 can be heated externally or internally and the temperature of transfer drum 352 is adjustable based on the materials being used. Alternatively, sufficient heat can be supplied to the materials 256 and transfer drum 352 by heaters 341, contact heaters 328 and 329, and heaters 354 and 360.

In order to form a strong layer in the part or support structure, the uncompressed powder materials 256 and the released materials 365 must be condensed or coalesced by applying heat and pressure to the materials. In some embodiments, this heat and pressure is applied on the transfer belt by heater 341 and rollers 328 and 329 and in the nip of the transfer belt with transfer drum 352. In other embodiments, this heat and pressure is applied on transfer drum 352 by heater 360 in the nip between transfer drum 352 and build roller 116 as part of the transfer process when material is transferred from transfer drum 352 and is bonded with previously printed portions of the parts and support structures on build roller 116. However, in accordance with the preferred embodiment of FIGS. 3-5, released materials 365 are condensed or coalesced on transfer drum 352 before the condensed material is transferred onto the previously printed parts and support structures.

In FIGS. 3-5, condensing or coalescing released materials 365 on transfer drum 352 begins by heating released materials 365 using heater 354. Heater 354 is much hotter than transfer drum 352 and includes one or more heating devices. Examples of suitable heating devices include non-contact radiant heaters (e.g., infrared heaters or microwave heaters with reflectors to direct radiant energy toward released material 365), convection heating devices (e.g., heated air blowers), contact heating devices (e.g., heated rollers and/or platens and/or ultrasonic heaters) as well as induction (magnetic field) or electric field heaters, combinations thereof, and the like, where non-contact radiant heaters and hot air heaters are preferred.

The heat from heater 354 raises the temperature of released materials 365 to or above the bonding temperature of all of the materials on transfer drum 352. This causes all of the materials to transition into a quasi-molten state where the materials are soft enough to be worked without cracking yet solid enough to remain in place on transfer drum 352.

In the next step of condensing or coalescing the material, sintering roller 356 applies pressure and optionally heat to released materials 365 to form condensed materials 366. Sintering roller 356 can be optionally heated internally or externally to a temperature that is above, at, or below the temperature of transfer drum 352 but is generally set above the bonding temperature or the glass transition temperature of released materials 365. Sintering roller 356 is spatially biased toward transfer drum 352 such that sintering roller 356 applies a constant force or pressure against released materials 365. The sintering roller applies significantly more pressure to the material on the transfer drum to condense the material than the pressure that is applied when the condensed material is transferred from the transfer member to the build cylinder. In accordance with some embodiments, the applied pressure is greater than 10 lb/in and for some materials is greater than 20 lb/in. Through this application of heat and pressure, condensed materials 366 are made denser and stronger than released materials 365. In accordance with one embodiment, condensed materials 366 have 5% or less of air by volume. Condensed materials 366 remain semisolid and are still pliable. Sintering roller 356 is electrically biased with respect to transfer drum 352 such that sintering roller 356 is at a voltage that repels released materials 365, which are electrostatically charged. After condensed materials 366 are formed, the outer surface of condensed materials 366 are treated by charging device 358, which is preferably a corona charger but could be a roller charger or another form of charger. In one embodiment, charging device 358 removes any residual electrostatic charge on condensed materials 366 and improves the bonding characteristics of the outer surface of condensed materials 366. In an additional embodiment, charging device 358 can be used to charge condensed materials 366 to the same polarity as the bias voltage on transfer roller 352 to aid separation of condensed materials 366 from transfer roller 352.

Although specific structures are describe above for forming a single layer of material for transfer onto build roller 116, in other embodiments, other techniques are used to form the single layer of material. In addition, although the single layer of material is shown to be placed on transfer roller 352 in order to be transferred onto build roller 116, in other embodiments, the single layer of material is placed on other structures for transfer onto build roller 116 or is formed directly on build roller 116.

Condensed materials 366 are then transferred onto build roller 116 to form transferred materials 368. In embodiments in which the completed build is to be removed from system 100 when the build is complete, a removable cylindrical base 349 is installed on build roller 116. In embodiments where the build cylinder is not removed from system 100, building can be done directly on build roller 116. In particular, condensed materials 366 are transferred onto removable cylindrical base 349 on build roller 116 as a continuous scroll of transferred materials 368 such that for a first rotation of build roller 116, condensed materials 366 are transferred onto the cylindrical base 349 of build roller 116 and for each subsequent rotation, condensed materials 366 are transferred on top of a previously transferred layer of transferred materials 368.

The transfer of condensed materials 366 begins with the transfer of condensed materials 366 from transfer roller 352 onto cylindrical base 349 or the outer layer of transferred materials 368. During this transfer, condensed materials 366 form an initial bond with cylindrical base 349 or transferred materials 368. To assist in the bonding between condensed materials 366 and the outer layer of transferred materials 368 or cylindrical base 349, heater 360 is used to heat the outer layer of transferred materials 368 or the outer layer of cylindrical base 349 before it reaches transfer drum 352. Heater 360 includes one or more heating devices. Examples of suitable heating devices for heater 360 include non-contact radiant heaters (e.g., infrared heaters or microwave heaters with reflectors to direct radiant energy toward transferred materials 368), convection heating devices (e.g., heated air blowers), contact heating devices (e.g., heated rollers and/or platens), combinations thereof, and the like, where non-contact radiant heaters are preferred. In accordance with one embodiment, heater 360 is positioned adjacent build roller 116 just before the position where condensed materials 366 are transferred from transfer drum 352 to build roller 116 to prevent previously transferred layers of transferred materials 368 from becoming too warm and thereby preserving the structural integrity of transferred materials 368.

To further assist in the bonding between condensed materials 366 and transferred materials 368, a charging device 359 can be used to charge transferred materials 368 to the opposite polarity of the charge on condensed materials 366. Charging device 359 can be a corona charger, roller charger, electron beam, or some other charging device. Preferably, the charge applied per unit area produced by charging device 359 is equal and of opposite polarity to the charge per unit area of condensed materials 366. Additionally, press roller 362 presses condensed materials 366 into transferred materials 368 after condensed materials 366 have been released from transfer drum 352 onto build roller 116. In accordance with one embodiment, press roller 362 is made of a relatively soft material, such as a material with 80 durometer (Shore A) or even 60 durometer (Shore A). In accordance with one embodiment, press roller 362 is maintained at a temperature that is above the bonding temperature and preferably above the glass transition temperature of condensed materials 366 to further assist in the bonding process. Once condensed materials 366 have been pressed by press roller 362, the condensed materials are considered to be part of transferred materials 368. Pressures of 10 psi to 30 psi and greater are sufficient between transfer drum 352 and build roller 116 as well as between press roller 362 and build roller 116.

Before a part is printed, a leader of material is applied to build roller 116. The surface of build roller 116 needs to be heated to a temperature greater than the glass transition temperature of the material. For a cylindrical spiral slice, a layer having a tapered thickness for the first revolution of build roller 116 can be printed by single-layer printers 106, 108, 109 and 110. For a cylindrical arc slice, a layer of constant thickness can be used. While a part is printed, to prevent the parts from sagging or otherwise deforming, the core of build roller 116 is cooled to a temperature below the glass transition temperature of transferred materials 368. To further assist in reducing the temperature of transferred materials 368, cooling roller 364 is placed in contact with the outer layer of transferred materials 368. In accordance with one embodiment, cooling roller 364 is maintained at a temperature far below the glass transition temperature of transferred materials 368. In accordance with other embodiments, non-contact coolers such as cooling air jets may be used in place of or in addition to cooling roller 364. Although surface cooling of transferred materials 368 may be required to remove excess heat, preferably, the temperature of previously transferred layers of transferred materials 368 is maintained at or slightly above the bonding temperature of the printed materials.

With each rotation of build roller 116, the radius of transferred materials 368 grows. To accommodate this growth, build roller 116 is continuously moved downward in direction 376 so that there is enough space between the outer layer of transferred materials 368 and transfer drum 352 to permit the transfer of the next layer of condensed materials 366. In addition, press roller 362 and cooling roller 364 are mounted to back wall 390 on respective pivot or slide assemblies 361 and 363 that allow press roller 362 and cooling roller 364 to move outward from build roller 116 as the radius of transferred materials 368 grows. Similarly, heater 360 and charging device 359 are mounted on pivot or slide assemblies to move outward from build roller 116 as the radius of transferred materials 368 grows. Preferably, these devices 359, 360, 362, 364 and any other required devices such as air blowers are driven by lead screws under control of stepper motors.

As shown in FIG. 5, build roller 116 is moved in direction 376 using a movable support platform 512, which supports build roller 116, a motor 510 for driving build roller 116, encoder 534 and a screw motor 514 for moving movable support platform 512. Movable support platform 512 is located behind back wall 390 and build roller 116 extends from support platform 512 into space 391 through opening 370 in back wall 390. Baffles or bellows 550 and 552 are positioned over opening 370 to reduce the amount of heat from space 391 that passes through opening 370. Movable support platform 512 includes one or more bearing assemblies that support build roller 116 while allowing build roller 116 to rotate in response to motor 510 turning a belt 516 or gear train that connects motor 510 to build roller 116.

Movable support platform 512 is slidably mounted on one or more smooth spindles 518, which are attached to back wall 390. A screw spindle 520, which is also fixedly attached to back wall 390, passes through screw motor 514. As screw motor 514 turns, it interacts with the threads of screw spindle 520 such that support platform 512 is moved along screw spindle 520 and smooth spindle 518. Preferably, a second screw spindle and a second screw motor are used in place of a smooth spindle 518. The second screw motor is synchronized with screw motor 514 by controller 103. Also, linear motors (not shown) can be used instead of screw motors 514 and screw spindles 520.

In accordance with one embodiment, screw motor 514 is turned at a continuous speed by controller 104. In accordance with other embodiments, controller 104 receives a signal from a position sensor 374 that is indicative of the height of the outer layer of transferred materials 368 and controller 104 uses this sensor signal to send command signals to screw motor 514 to maintain the outer layer at the desired height. In various embodiments, the build roller 116 is lowered a fixed distance once per revolution, or a lowered a few times per revolution, lowered every printed point, or lowered at a constant rate per revolution. Although a screw motor is shown in FIG. 5, in other embodiments other actuation mechanisms are used to move support platform 512, such as linear motors fitted with linear encoders.

In order for condensed material 366 to be successfully transferred, the tangential velocity along the outer circumference of transfer drum 352 must match the tangential velocity along the outer circumference of transferred materials 368. However, because the circumference of transferred materials 368 is continuously increasing, the tangential velocity at the outer circumference will continue to increase if the angular speed of motor 510 remains constant. In accordance with one embodiment, the tangential velocity of the outer circumference of transferred materials 368 is maintained at the same velocity as transfer drum 352 by using a torque-limited motor for motor 510. With such a motor, as the radius of transferred materials 368 grows, the angular velocity of motor 510 decreases to maintain the same tangential velocity at the outer circumference. In accordance with one embodiment, the torque setting for motor 510 is provided by controller 104 based on the weight of the materials being transferred and the speed of transfer drum 352. In accordance with other embodiments, encoder 534 is monitored by controller 104 to control the speed of motor 510 or the total travel of build roller 116 based on the expected progression of the build. Screw motor 514 or a similar actuator can be similarly monitored by an encoder and controlled by controller 104 to lower build roller 116 to match the expected progression of the build. Encoder 532 for roller 352 may be similarly monitored for progression of the build, as well as other encoders in the system. These other encoders can include encoders in the single-layer 106, 108, 109, and 110, such as encoders on the photoconductor drums 212 as are commonly used in electrophotographic printers. In a preferred embodiment, controller 104 sends command signals to motor 510 to advance the total distance travelled by roller 352 based on the expected progression of the build. Controller 104 also sends command signals to screw motor 514 to control the height of build roller 116 to match the expected progression of the build.

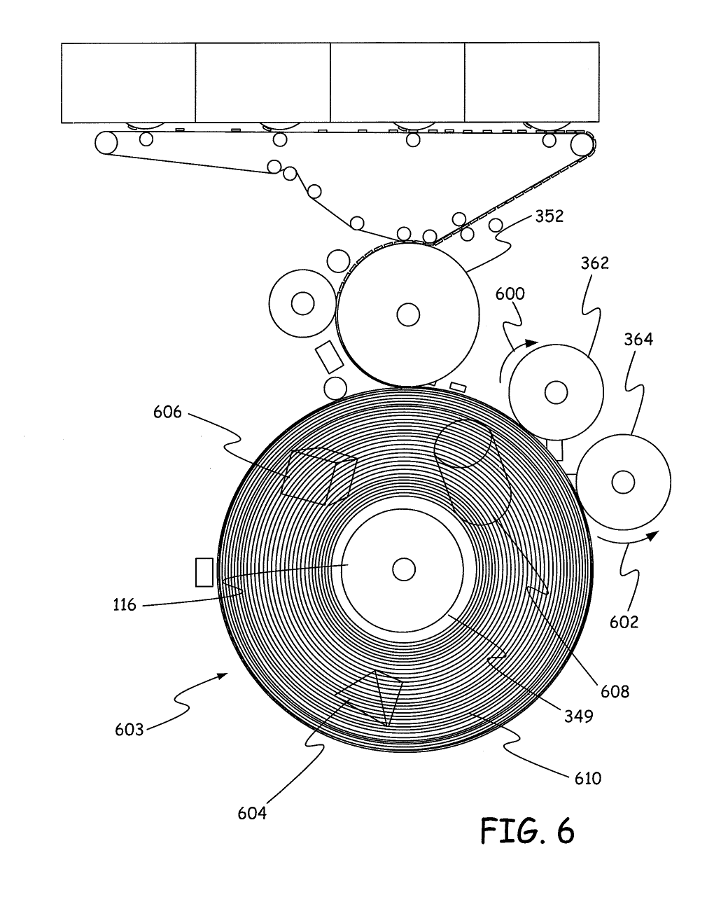

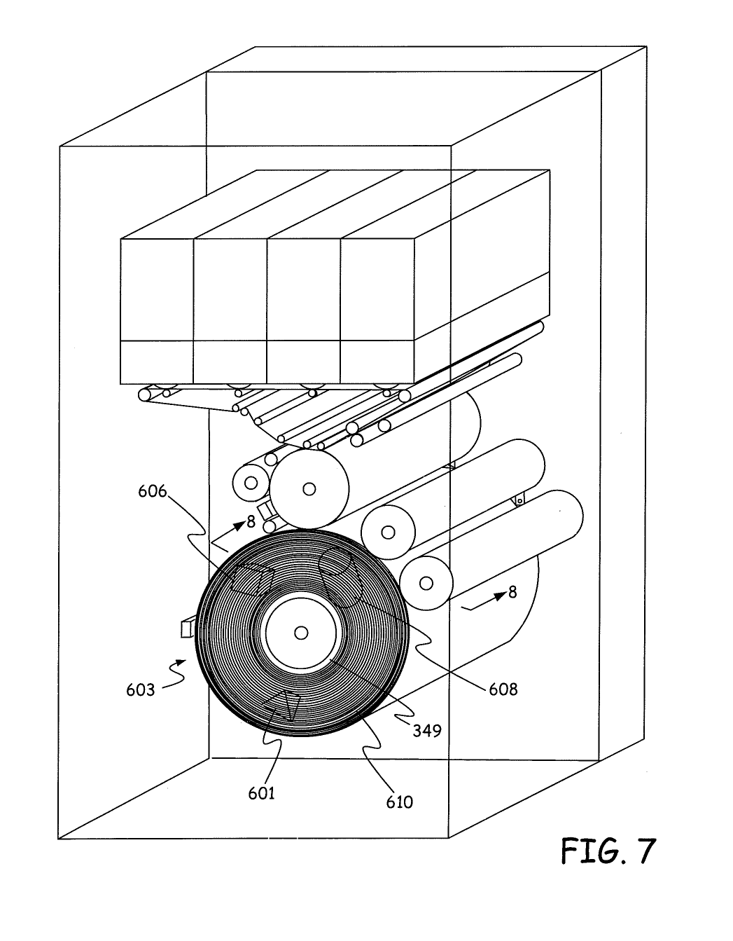

FIGS. 6 and 7 show a front view and a perspective view of the portions of system 100 of FIGS. 3 and 4 after a number of layers of transferred materials 368 have been built on build roller 116 to form a build cylinder 603 that includes multiple parts, such as parts 604, 606 and 608, that are interspersed within a cylindrical support structure 610. As shown in FIGS. 6 and 7, build roller 116 has been moved downward relative to transfer drum 352 and press roller 362 and cooling roller 364 have been moved outward along directions 600 and 602, respectively, to accommodate the larger radius of build cylinder 603 compared to cylindrical base 349 of build roller 116. Other components such as heaters and charging devices have also been moved away from build roller 116 to accommodate the larger radius of build cylinder 603.

The weight of cylindrical support structure 610 has a large impact on the size of motor 510 needed to turn build roller 116 and the amount of structural support that must be provided on movable platform 512 to support build roller 116. In accordance with some embodiments, cylindrical support structure 610 is printed on build roller 116 so that there are a large number of voids or spaces in cylindrical support structure 610 to reduce the overall weight of cylindrical support structure 610.

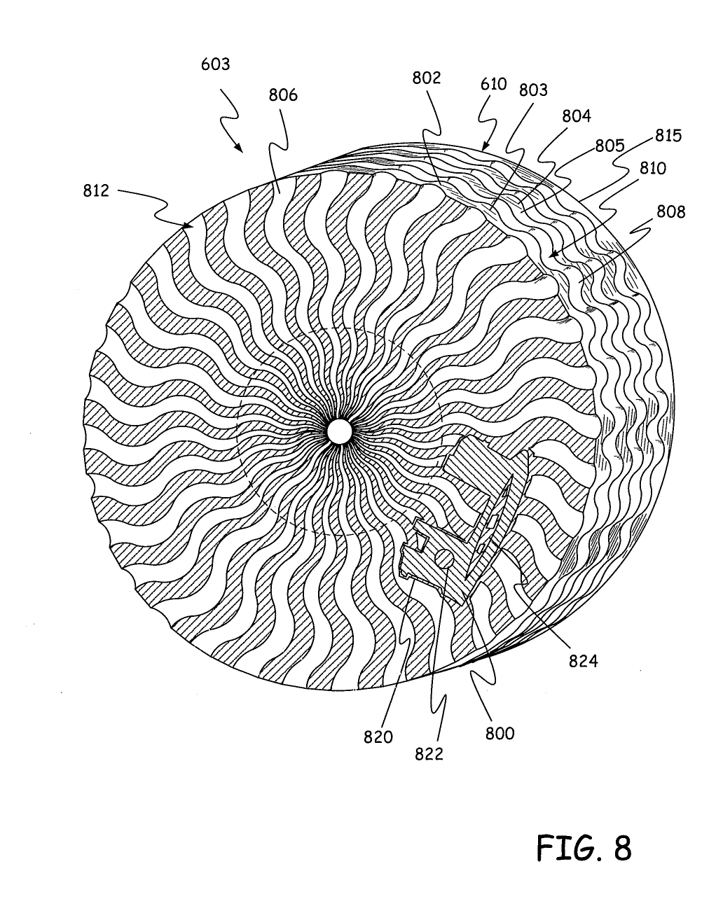

FIG. 8 provides a sectional perspective view of a portion of build cylinder 603 taken through line 8-8 of FIG. 7 in accordance with one embodiment. In FIG. 8, a part 800 is shown built within cylindrical support structure 610. Cylindrical support structure 610 is shown to include cylindrical support slices, such as cylindrical support slices 802 and 804. Each cylindrical support slice can have wavy axial faces, such as wavy axial face 806 of cylindrical support slice 802 and wavy axial face 808 of cylindrical support slice 804, and some support slices can have cylindrical exterior surfaces such as cylindrical exterior surfaces 803 and 805. The outside edges of build cylinder 603 have continuous tires 815 of support material. These can be used to guide rollers 362 and 364. Additional tires may be built in the interior of the build cylinder for structural integrity. A space is formed between neighboring slices such as space 810 between cylindrical support slices 802 and 804 and space 812 between cylindrical support slice 802 and the cylindrical support slice (not shown) opposite cylindrical support slice 802. The spaces between the cylindrical support slices reduce the weight of cylindrical support structure 610 while the wavy axial faces ensure sufficient support for portions of the part that extend circumferentially within a space. In other embodiments, the axial faces are shaped differently than shown in FIG. 8. In accordance with the embodiment of FIG. 8, the shape of the axial faces is modulated around the boundaries of part 800 to provide a structural support encasement 820 and void filling portions 822 and 824. Encasement 820 and void filling portions 822 and 824 provide additional support along the boundaries of part 800 and in one embodiment each exterior surface of the part is covered by structural support material of encasement 820 or a void filling portion such as void filling portions 822 and 824.

In accordance with other embodiments, cylindrical support structure 610 is constructed as a lattice having empty spaces surrounded by structural elements. In accordance with one such embodiment, the lattice is modulated such that the empty spaces in the lattice become smaller the closer the lattice is to a surface of a part. This results in a solid support structure next to each part surface and a porous structure elsewhere in cylindrical support structure 610. In other embodiments, the support structure can be built between the part and cylindrical base 349 of build roller 116, leaving empty space between portions of the part and the outer diameter of the volume occupied by the build cylinder 603.

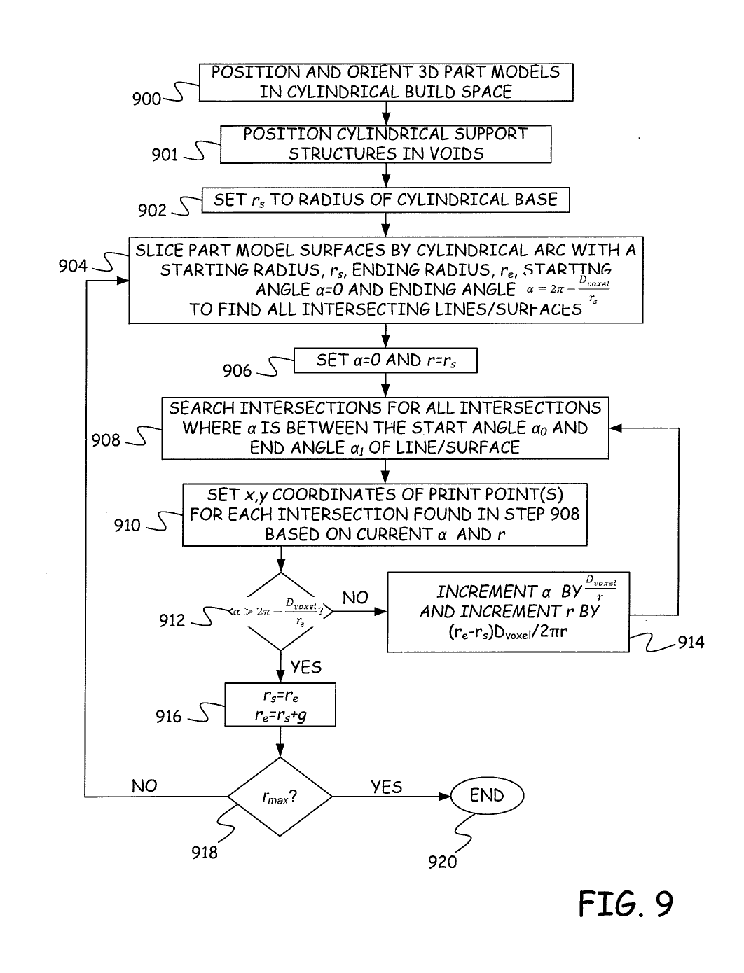

As discussed above, in accordance with the several embodiments, parts are printed as a continuous scroll on rotating build roller 116. In order to print parts in this fashion, three-dimensional models that describe the surfaces of the parts and the surfaces of the structural support cylinder must be converted into instructions for printing patterns of material on the transfer belt. FIG. 9 provides a flow diagram in accordance with one method of converting three-dimensional models into a collection of print points on the transfer belt. The process of FIG. 9 is performed by a graphical processing unit that is part of host computer 102 or that is part of a computing device that provides print data to host computer 102.

At step 900, three-dimensional models of the parts are oriented in a cylindrical build space corresponding to the volume that parts can be built within on build roller 116. The build space is a cylindrical volume with a hollow core corresponding to the outer circumference of cylindrical base 349 of build roller 116. The cylindrical volume has an outer radius equal to a selected maximum radial size for transferred materials 368 and a length corresponding to the effective length of the photoconductor drums 212. Note that the effective length of photoconductor drums 212 can be extended beyond the length of one photoconductor drum by axially offsetting multiple photoconductor drums. Parts may be oriented in any desired position.

At step 901, three-dimensional models of the cylindrical support structure are positioned in the voids in and around the three-dimensional models of the parts. In accordance with one embodiment, intersections between the parts and the cylindrical support structure are identified and the surfaces of the cylindrical support structure are redefined to eliminate the portions of the cylindrical support structure that would otherwise occupy a volume filled by a surface of one of the parts. In some embodiments, in which the cylindrical support structure is formed of a lattice or otherwise includes empty spaces, the cylindrical support structure is modulated based on the distance to a surface of a part such that the empty spaces become smaller or non-existent next to the surfaces of the part.

For a cylindrical spiral slice, at step 902, a radius start variable, rₛ, is set to the radius of cylindrical base 349 and a radius end variable, rₑ, is set to rₛ plus the thickness, g, of one layer of condensed materials 366. At step 904, a cylindrical spiral is defined that starts at angle α=0 with radius rₛ, and ends at angle

$$α = 2 π - \frac{{D}_{voxel}}{{r}_{e}}$$

with radius rₑ, where Dᵥₒₓₑₗ is the diameter of a single printed point along the cylindrical arc. The intersections of the volume of this arc with the surfaces of the three-dimensional models in the cylindrical build space are then determined. These intersections can be points, lines or surfaces and represent one cylindrical slice of the surfaces of the three-dimensional models. Each intersection is described as equations for x,y coordinates in terms of angle α along the cylindrical spiral, radius r along the cylindrical spiral, where rₛ<r<rₑ, and boundary conditions α₀, α₁, which define the angular extent or span α₀<α<α₁ of the intersection on build roller 116. The x,y coordinates are defined in the plane beneath single-layer printers 106, 108, 109 and 110 with x aligned with the direction of movement of the transfer belt beneath the single-layer printers and y aligned with the width of the transfer belt (into the page in FIG. 3).

At step 906, angle variable α is set to α=0 and radius variable r is set to rₛ. At step 908, the boundary conditions α₀, α₁ of each intersection are examined to determine if a is between α₀ and α₁ for the intersection. If a is between the boundary angles of an intersection, the equations describing the x,y coordinates of the intersection are retrieved and the current values of a and r are used to compute the x,y coordinates for a print point for the intersection at step 910. For intersections that extend along the length of build roller 116 at angle α and radius r, the equation for the y coordinates defines a print line instead of a single print point. Note that for any one pair of values α,r, print points can be stored for multiple surfaces of a single part and for surfaces of different parts.

In accordance with some embodiments, each surface in each three-dimensional model has an associated material that the surface is to be constructed from. As part of storing the x,y coordinates for a print point in memory, a designation is made to indicate what material is to be used to print that point. This designation can be made in a separate field in an entry for the print point or can be made by storing the print point in a file that only receives print points for a single material. For example, a separate file can be generated for each of the single-layer printers such that when two different single-layer printers print different respective materials, each single-layer printer only receives printing coordinates for the points that use the single-layer printer's particular material.

After the print points have been determined for the parts and the cylindrical support structure, the value of angle α is compared to its maximum value,

$$\begin{matrix}α = α + \frac{{D}_{voxel}}{r} & ( Equation 1 ) \\ r = r + ( {r}_{e} - {r}_{s} ) \frac{{D}_{voxel}}{2 π r} & ( Equation 2 )\end{matrix}$$

at step 912. If the maximum value has not been reached, the values of α and r are incremented at step 914 as:

$$2 π - \frac{{D}_{voxel}}{{r}_{e}} ,$$

The process then returns to step 908 to search for all intersections that span the new values of α and r and step 910 is repeated for each of those intersections.

When angle α has reached its maximum value at step 912, a new cylindrical spiral is defined by setting the starting radius of the new arc to the ending radius of the previous spiral, r_{s:new}=r_{e:prev}. and then setting the ending radius of the new spiral to the size of the starting radius of the new spiral plus the thickness of one layer of condensed materials 368, r_{e:new}=r_{s:new}+g. Note that the new cylindrical spiral is continuous with the previous spiral such that all of the cylindrical spirals together form a single continuous scroll.

The size of the new starting radius is compared to the selected maximum radial size for transferred materials 368 at step 918. If the new starting radius is smaller than the maximum radial size, the process returns to step 904 to identify intersections between the new cylindrical spiral and the surfaces of the three-dimensional models in the cylindrical build space. Steps 906-916 are then repeated for the new intersections. When determining the x coordinates of the intersections with the new cylindrical arc, the maximum x coordinate associated with the previous arc is used as a base. For example, the x coordinate for an intersection is defined as x=x_{max:prev} αr in accordance with one embodiment, where x_{max:prev} is the maximum x coordinate associated with the previous cylindrical arc and a and r describe a position on the current cylindrical arc. By using the previous maximum x coordinate as a base for the next cylindrical arc, the x coordinates increase with each cylindrical arc instead of being reset to zero due to the reset of angle α to zero at the start of each cylindrical arc. When the starting radius reaches the maximum radial size, the process ends at step 920.

The process of FIG. 9 improves the efficiency of the graphical processing unit used to identify the print points. In particular, the x,y coordinates for the print points are determined and stored in the same order in which they will be printed. As a result, the graphical processing unit does not have to perform a separate step of organizing the print points before the print points can be printed. Given the large number of print points and the complexity of converting from the cylindrical build space to the x,y plane used by the single-layer printers, removing the need for such an organizing step greatly reduces the amount of processing that the graphical processing unit must perform. As noted above, in some embodiments, a separate file of print points is stored for each single-layer printer. In such embodiments, each file may contain a print point for a same x position. Within each file, the print points are organized with increasing x coordinates.

In the description above, a three-dimensional model of the structural support cylinder was generated and used to identify intersections between the cylindrical arcs and the structural support cylinder. In other embodiments, print points for the structural support cylinder can be formed without forming a three-dimensional model of the structural support cylinder. Instead the x,y coordinates for print points for the structural support cylinder are determined by identifying all of the print points that have been identified for the parts at each value of a and r and then filling in the empty areas with print points for the structural support cylinder. In accordance with one embodiment, the empty areas are not completely filled. Instead, a lattice is defined in the empty areas so that the resulting structural support cylinder is porous and thus weighs less. In such embodiments, the spacing of the lattice can be reduced around surfaces of the parts to provide more structural support to the parts, and a solid layer of support material can be made around each part or underneath each part.

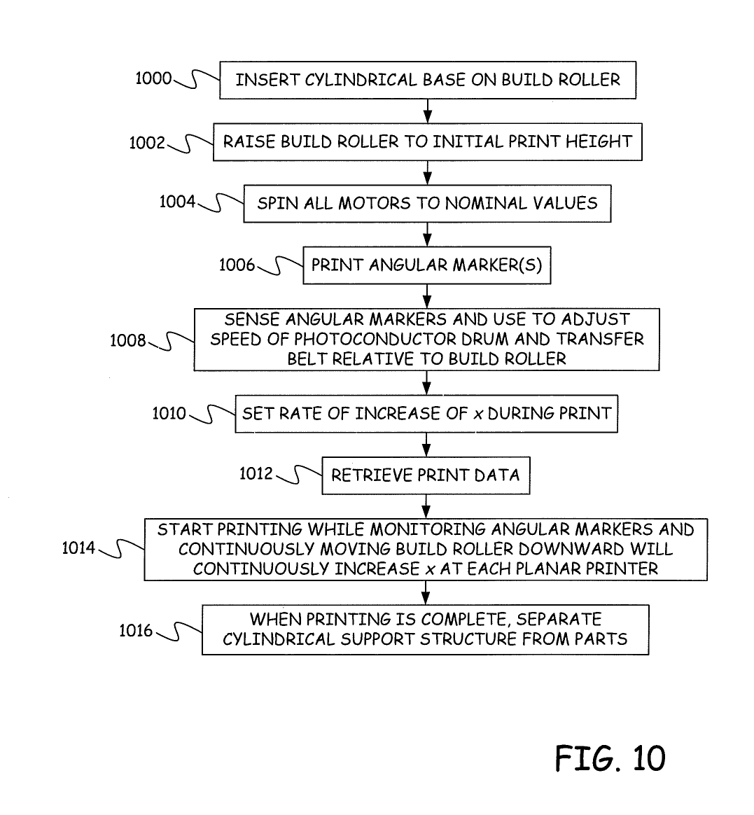

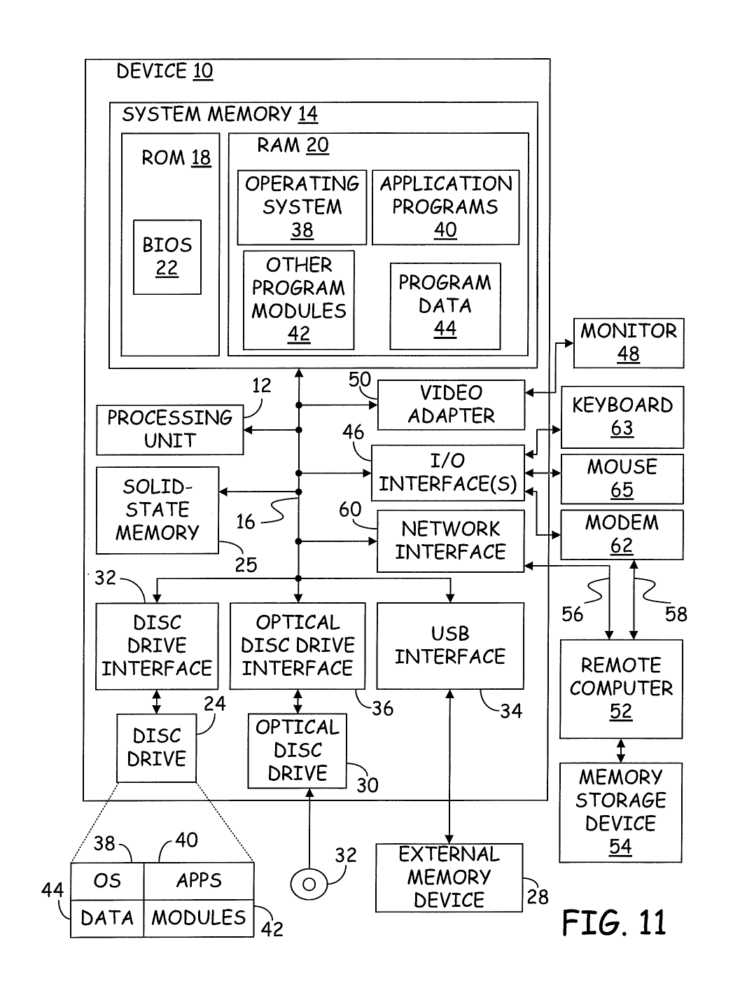

Once the x,y coordinates for the print points have been determined, the parts can be printed. FIG. 10 provides a flow diagram of a method of printing parts using system 100.

In embodiments in which the build cylinder, such as build cylinder 603, is to be removed from system 100 when the build is complete, a removable cylindrical base 349 is installed on build roller 116 at step 1000. In embodiments where the build cylinder is not removed from system 100, the cylindrical base 349 can be a permanent part of build roller 116 or the build can be made directly onto build roller 116.

At step 1002, the cylindrical base is raised to the initial printing height and at step 1004 all of the printing motors are spun to their nominal rotational velocities. With the motors at their nominal speed, angular markers can be printed on cylindrical base 349 at step 1006. In accordance with one embodiment, step 1006 involves at least one single-layer printer printing a series of angular markers that should align with each other on cylindrical base 349. In other words, the angular markers are spaced in the x direction by an amount equal to 2πr₀, where r₀ is the outer radius of cylindrical base 349. If the tangential velocity of build roller 116 is different from the speed of rotation of the transfer belt, the angular markers will not be aligned.

At step 1008, an optical sensor 372 (FIGS. 3 and 5) senses the positions of the angular markers and provides a signal indicative of the positions of the angular markers to controller 104. Based on these signals, controller 104 adjusts one or more of the speed of the transfer belt and motor 510, which drives build roller 116, until successive angular markers are aligned on build roller 116. With the speed of the transfer belt set, the rate of increase of x during printing is set to correspond with that speed at step 1010.

At step 1012, the print data is retrieved and at step 1014, printing is started. During printing, controller 104 constantly increases the value of x and prints points that have the corresponding x,y coordinates using single-layer printers 106, 108, 109 and 110. As the parts and support structure cylinder are printed, optical sensor 372 provides a signal indicative of when an angular marker passes the sensor. This signal is used by controller 104 to adjust the speed of the transfer belt relative to build roller 116 so that successive layers of the printed parts and support structure cylinder are properly aligned with previously deposited layers of the parts and support structure cylinder. In addition, during printing, controller 104 constantly moves build roller 116 downward. In some embodiments, controller 104 uses the sensor signal from height sensor 374 to ensure that build roller 116 is being moved by the correct amount.

Coordination of the transfer roller 352 and the build cylinder 603 can be done in similar fashion using encoder pulses from encoders 532 and 534 in FIG. 5. In this case, controller 104 monitors the x coordinate of the build as well as monitoring encoders 532 and 534. Based on the x coordinate of the build, the initial diameter of removable cylindrical base 349 and the expected thickness g of one layer of condensed materials 368, the controller 104 adjusts the speed of motor 510 so that the total travel of the surface of build cylinder 603 corresponds to the x coordinate of the build. Also, the controller 104 adjusts the total travel of screw motor(s) 514 based on the expected diameter of build cylinder 603.

When printing is complete, the parts are separated from the support structure cylinder at step 1016. In accordance with one embodiment, the parts are separated from the support structure by removing build cylinder 603 from housing 120 and placing build cylinder 603 in a washer that contains an aqueous-based solution (e.g., an aqueous alkali solution). The aqueous-based solution dissolves the structural support cylinder without degrading the shape or quality of the parts. Different formats for the washer are possible. In accordance with one embodiment, the washer contains a tub filled with the aqueous-based solution and build cylinder 603 is submerged in the tub. Once the support structure has dissolved, the freed parts are lifted out of the tub and allowed to dry. In accordance with other embodiments, the washer contains one or more spray nozzles that spray the aqueous-based solution on build cylinder 603 until the parts are freed of the support structure material.

In accordance with a further embodiment, components of the washer are mounted within housing 120 such that build cylinder 603 remains in housing 120 while the aqueous-based solution is applied. In accordance with one such embodiment, build cylinder 603 remains on build roller 116 and continues to be rotated by build roller 116 while nozzles 402 (FIG. 4) in housing 120 spray build roller 116 with the aqueous-based solution. As the support structure cylinder dissolves, parts in build cylinder 603 are released and fall into drawer 400 in the bottom of housing 120. The drawer can then be pulled out of housing 120 and the parts can be removed. In accordance with a further embodiment, drawer 400 is filled with the aqueous-based solution and build roller 116 is lowered so that build cylinder 603 is partially submerged in the aqueous-based solution. Build roller 116 is then rotated so that all of build cylinder 603 pass through the aqueous-based solution until the parts are freed.

An example of a computing device 10 that can be used as host computer 102 or as part of controller 104 is shown in the block diagram of FIG. 11. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Processing unit 12 can include one or more processors including specialty processors such as graphics processing units.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, a solid state memory 25, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives, solid state memory and external memory devices and their associated computer-readable media provide nonvolatile storage media for computing device 10 on which computer-executable instructions and computer-readable data structures may be stored. Other types of media that are readable by a computer may also be used in the exemplary operation environment.

A number of program modules may be stored in the drives, solid state memory 25 and RAM 20, including an operating system 38, one or more application programs 40, other program modules 42 and program data 44. For example, application programs 40 can include instructions for orienting and slicing three-dimensional models of parts and support structures as found in the flow diagram of FIG. 9 as well as instructions for manufacturing system 100 and controller 104. Program data 44 can include the stored print points created through the process of FIG. 9 that are used by controller 104 to control the single-layer printers during printing.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

Computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 11. The network connections depicted in FIG. 11 include a local area network (LAN) 56 and a wide area network (WAN) 58. Such network environments are commonplace in the art.

Computing device 10 is connected to the LAN 56 through a network interface 60. Computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 11 are exemplary and other means for establishing a communications link between the computers, such as a wireless interface communications link, may be used.

Although elements have been shown or described as separate embodiments above, portions of each embodiment may be combined with all or part of other embodiments described above.

Although the present disclosure has been described with reference to preferred embodiments, workers skilled in the art will recognize that changes may be made in form and detail without departing from the spirit and scope of the disclosure.

1. An additive manufacturing system for printing a three-dimensional part, the additive manufacturing system comprising:
an electrophotographic imaging engine configured to form layers of part material; and
a build roller that rotates while receiving part material such that layers of part material are formed on a cylindrical base of the build roller in a cylindrical scroll to form the three-dimensional part, wherein the part material of adjacent layers of part material are bonded together on the build roller, and wherein the three-dimensional part can be non-cylindrical.

2. The additive manufacturing system of claim 1 wherein the build roller also receives layers of structural support material such that the cylindrical scroll comprises continuous layers of part material and structural support material and the structural support material forms a cylindrical structural support on the build roller around the three-dimensional part.

3. The additive manufacturing system of claim 2 wherein the build roller receives a continuous web of material that contains the part material and the structural support material.

4. The additive manufacturing system of claim 2 wherein the structural support material is dissolvable in a solution that does not affect the three-dimensional part.

5. The additive manufacturing system of claim 1 further comprising receiving additional part material such that cylindrical layers of the additional part material are formed on the build roller such that while the three-dimensional part is formed a second three-dimensional part is formed.

6. The additive manufacturing system of claim 5 wherein the part material comprises multi-materials.

7. (canceled)

8. A computer-implemented method comprising:
orienting a part surface in a cylindrical build space;
identifying an intersection between the part surface and a cylindrical spiral;
for each of a set of discrete angle values along the cylindrical spiral at which the intersection is present, storing at least one print point in memory, wherein the print points are determined and stored in memory in a same order in which the print points will be printed.

9. The computer-implemented method of claim 8 wherein orienting the part surface comprises orienting a part having a plurality of part surfaces and identifying an intersection further comprises identifying all intersections between the plurality of part surfaces and the cylindrical spiral.

10. The computer-implemented method of claim 9 wherein storing print points in the order in which they will be printed comprises storing print points for multiple part surfaces for a single discrete angle value.

11. The computer-implemented method of claim 10 wherein the cylindrical spiral forms part of a continuous scroll that has a continuously increasing radius with changes in the angle value and the method further comprises identifying a plurality of intersections between the part surface and the continuous scroll.

12. The computer-implemented method of claim 11 wherein storing print points in the order in which they will be printed comprises storing print points for intersections with the continuous scroll so that print points associated with a smaller radius for the continuous scroll are stored before print points associated with a larger radius for the continuous scroll

13. The computer-implemented method of claim 8 wherein the part surface forms a portion of a first part and the method further comprises:
orienting a part surface of a second part in the cylindrical build space;
identifying an intersection between the part surface of the second part and the cylindrical spiral;
for each of a set of discrete angle values along the cylindrical spiral at which the intersection between the part surface of the second part and the cylindrical spiral is present, storing at least one print point in memory, wherein the print points are stored in memory in a same order in which the print points will be printed.

14. The computer-implemented method of claim 13 wherein for at least one discrete angle value, a print point for the first part and a print point for the second part are stored in memory.

15. The computer-implemented method of claim 8 wherein storing a print point comprises storing a coordinate in an x,y plane for the print point.

16. The computer-implemented method of claim 15 wherein storing a print point comprises storing the coordinate for the print point in a file dedicated to printing points of a single material.

17. An additive manufacturing system comprising:
an electrophotographic print engine printer that prints material onto a conveyor assembly; and
a transfer medium that receives the material from the conveyor assembly and transfers the material onto a build cylinder in a cylindrical scroll to build one or more 3D parts in a layerwise manner in the cylindrical scroll.

18. The additive manufacturing system of claim 17 wherein the transfer medium comprises a transfer drum and wherein the transfer medium releases the material onto the transfer drum and the transfer drum transfers the material onto the build cylinder.

19. The additive manufacturing system of claim 18 further comprising a sintering roller that applies heat and pressure to the material on the transfer drum to form a condensed layer on the transfer drum, wherein the material released onto the build cylinder comprises the condensed layer.

20. The additive manufacturing system of claim 19 further comprising a press roller that presses the condensed layer into the build cylinder after the condensed layer is released onto the build cylinder to thereby form a transferred layer.

21. The additive manufacturing system of claim 20 further comprising a charging device that is configured to apply a charge to the condensed layer before the condensed layer is released onto the build cylinder.

22. The additive manufacturing system of claim 20 further comprising a cooling roller that cools the cylindrical scroll on the build cylinder.

23. The additive manufacturing system of claim 18 wherein the build cylinder rotates with an angular velocity that slows with each rotation of the build cylinder.

24. The additive manufacturing system of claim 23 wherein the transfer drum rotates at a substantially fixed speed.

25. The additive manufacturing system of claim 23 wherein the build cylinder is driven by a torque-limited motor.
